(19) United States
(12) Patent Application Publication
(10) Pub. No.: US 2025/0192929 A1
(43) Pub. Date: Jun. 12, 2025

(54) ENHANCING COMMUNICATION IN AMBIENT IOT WITH WIRELESS ENERGY TRANSMITTERS

(71) Applicant: QUALCOMM Incorporated, San Diego, CA (US)

(72) Inventors: Piyush GUPTA, Bridgewater, NJ (US); Junyi LI, Fairless Hills, PA (US); Xiaoxia ZHANG, San Diego, CA (US)

(21) Appl. No.: 18/535,930

(22) Filed: Dec. 11, 2023

(51) Int. Cl. H04L 5/00; H04W 72/0446; H04W 72/1273

(52) U.S. Cl. CPC H04L 5/0005; H04W 72/0446; H04W 72/1273

(57) ABSTRACT

Aspects relate to enhancing communication between ambient IoT devices and network entities using wireless energy transmitter (WET) devices. A WET device may be configured to provide a continuous wave (CW) signal to an ambient IoT device to both power the ambient IoT device and facilitate backscattering and modulation of the CW signal by the IoT device. The IoT device may then transmit the backscattered and modulated CW signal as an uplink transmission to a network entity for processing of the modulated CW signal. The WET device may further avoid interference with a downlink transmission from the network entity by avoiding transmission of the CW signal within downlink slots, transmitting the CW signal within a different frequency band than the downlink transmission, and/or transmit the CW signal on a helper tone separated in frequency from a data tone of the downlink transmission.

### TECHNICAL FIELD

The technology discussed below relates generally to wireless communication networks, and more particularly, to mechanisms for ambient Internet of Things (IoT) communication.

### INTRODUCTION

The 3rd Generation Partnership Project (3GPP) has specified several cellular technologies for applications related to the Internet of Things (IoT) in licensed spectrum, including Long Term Evolution (LTE) for machine-type communications (LTE-M), narrowband IoT (NB-IoT) supporting massive machine type communication (mMTC), reduced capability (RedCap) for MTC, extended-coverage GSM for IoT (EC-GSM-IoT), and ultra-reliable low-latency communications (URLLC). Applications include, for example, sensors, surveillance cameras, wearable devices, smart meters and smart meter sensors. To meet the power requirements in 5G New Radio (NR) and IoT wireless communications, IoT devices may be configured to perform radio frequency (RF) energy harvesting to accumulate energy over time.

IoT devices may include, for example, active IoT devices, passive IoT devices, and semi-passive IoT devices, each being capable of harvesting the ambient energy from RF signals or other ambient energy sources. For example, in active IoT devices, the accumulated energy can charge a power source (e.g., a battery) of the IoT device to perform various tasks, such as data reception, data decoding, data encoding, and data transmission. In some examples, data transmission may include a backscattering technique in which the IoT device both harvests energy from an incident RF waveform and modulates and reflects a fraction of the wave as a backscattered and modulated signal.

Passive IoT devices, such as radio frequency identification (RFID) devices, may include, for example, include small transponders, or tags, capable of harvesting energy over the air to power the transmission/reception circuitry, thereby enabling a backscattered modulated information signal to be transmitted. Passive RFID sensors may be used, for example, in asset management, logistics, retail environments, warehousing, and manufacturing.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a wireless energy transmitted (WET) device is provided. The WET device includes one or more memories and one or more processors coupled to the one or more memories. The one or more processors may be configured to configure a continuous wave (CW) signal to avoid interference with a downlink transmission from a network entity and transmit the CW signal for wireless power transfer to at least one ambient Internet of Things (IoT) device.

Another example provides an ambient Internet of Things (IoT) device. The ambient IoT device includes one or more memories and one or more processors coupled to the one or more memories. The one or more processors may be configured to receive a continuous wave (CW) signal for wireless power transfer from a wireless energy transmitter (WET) device, backscatter and modulate at least the CW signal to produce a modulated CW signal, and transmit the modulated CW signal to a network entity separate from the WET device.

Another example provides a network entity including one or more memories and one or more processors coupled to the one or more memories. The one or more processors may be configured to provide a downlink transmission to an ambient Internet of Things (IoT) device, and receive a modulated continuous wave (CW) signal backscattered from the ambient IoT device based on a CW signal originated at a wireless energy transmitter (WET) device separate from the network entity.

Another example provides a method operable at a wireless energy transmitter (WET) device. The method includes configuring a continuous wave (CW) signal to avoid interference with a downlink transmission from a network entity and transmitting the CW signal for wireless power transfer to at least one ambient Internet of Things (IoT) device.

Another example provides a method operable at an ambient Internet of Things (IoT) device. The method includes receiving a continuous wave (CW) signal for wireless power transfer from a wireless energy transmitter (WET) device, backscattering and modulating at least the CW signal to produce a modulated CW signal, and transmitting the modulated CW signal to a network entity separate from the WET device.

Another example provides a method operable at a network entity. The method includes providing a downlink transmission to an ambient Internet of Things (IoT) device, and receiving a modulated continuous wave (CW) signal backscattered from the ambient IoT device based on a CW signal originated at a wireless energy transmitter (WET) device separate from the network entity.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless communication system and an access network according to some aspects.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram providing a high-level illustration of one example of a configuration of a disaggregated base station according to some aspects.

FIG. 4 is a diagram illustrating an example of ambient Internet of Things (IoT) communication according to some aspects.

FIG. 5 is a diagram illustrating an example of a passive IoT device according to some aspects.

FIG. 6 is a diagram illustrating an example of an active IoT device with energy harvesting according to some aspects.

FIG. 7 is a diagram illustrating an example of an ambient IoT slot format according to some aspects.

FIG. 8 is a diagram illustrating an example of WET-assisted uplink transmission from an IoT device to a network entity, according to some aspects.

FIG. 9 is a diagram illustrating an example of time-division multiplexing of downlink transmissions and continuous wave (CW) signals according to some aspects.

FIG. 10 is a graph illustrating an example of frequency-division multiplexing of downlink transmissions and CW signals according to some aspects.

FIG. 11 is a diagram illustrating an example of helper tone CW transmissions according to some aspects.

FIG. 12 is a diagram illustrating an example of an ambient IoT synchronization signal block (SSB) according to some aspects.

FIG. 13 is a block diagram illustrating an example of a hardware implementation for a WET device employing a processing system according to some aspects.

FIG. 14 is a flow chart of an exemplary process for enhancing communication between network entities and ambient IoT devices using WET devices according to some aspects.

FIG. 15 is a block diagram illustrating an example of a hardware implementation for an ambient IoT device employing a processing system according to some aspects.

FIG. 16 is a flow chart of another exemplary process for enhancing communication between network entities and ambient IoT devices using WET devices according to some aspects.

FIG. 17 is a block diagram illustrating an example of a hardware implementation for a network entity employing a processing system according to some aspects.

FIG. 18 is a flow chart of another exemplary process for enhancing communication between network entities and ambient IoT devices using WET devices according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

Ambient Internet of Things (IoT) devices, such as active IoT devices, passive IoT devices (e.g., RFID tags), or semi-passive IoT devices, may harvest energy from one or more ambient energy sources, including solar/heat energy sources, vibration energy sources, or radio frequency (RF) energy sources. RF energy sources may include, for example, network entities, which may include RFID readers, base stations (e.g., gNBs or other base station configurations/designs), or other network access devices, and/or other suitable RF energy sources (e.g., television). In addition, wireless energy transmitter (WET) devices have been introduced to provide RF energy transmissions to IoT devices to assist in powering IoT devices. As the receive power of RF signals from network entities may be insufficient to initiate energy harvesting at some IoT devices, WET devices may be deployed to enhance and increase the wireless power transfer (WPT) to IoT devices at a reduced cost and footprint as compared to network entities.

Various aspects are related to enhancing and aiding communication between IoT devices and network entities using WET devices. In some examples, a WET device may be configured to provide a continuous wave (CW) signal to an ambient IoT device to both power the ambient IoT device and facilitate backscattering and modulation of the CW signal by the IoT device. The IoT device may then transmit the backscattered and modulated CW signal as an uplink transmission to a network entity for processing of the modulated CW signal. By utilizing a WET device to assist in uplink communication from the IoT device to the network entity, the network entity may not need to perform self-interference cancellation (e.g., between the downlink transmission of the network entity and the uplink transmission of the IoT device), thus reducing the processing requirements of the network entity. Moreover, with the increased separation between transmit and receive antennas, the IoT device can implement a smaller frequency shift of the uplink transmission to enable decoding at the network entity (e.g., a frequency shift less than that needed to backscatter an RF signal from the network entity). In addition, existing WET devices may be used, which have a lower complexity, lower cost, and are easier to deploy than RFID readers or network entities.

In some examples, the CW signal may be configured to minimize or prevent interference between the CW signal sent from the WET device and a downlink transmission (e.g., downlink control and/or data) sent from the network entity. In some examples, the WET device may receive a slot format indicator (SFI) from the network entity identifying one or more downlink slots for communication of downlink control and/or data from the network entity to the IoT device. The WET device may then avoid transmission of the CW signal within the one or more downlink slots. To receive the SFI, the WET device may be configured to decode a system information block (SIB) provided by the network entity.

In other examples, the CW signal may be transmitted in a different frequency band (e.g., a higher frequency band) than the downlink transmission. In this example, the complexity of the WET may remain low with one-time programming of the frequency band. In other examples, the CW signal may be sent on a helper tone separated in frequency from a data tone of the downlink transmission. The helper tone may further aid in reducing interference with other downlink transmissions from other nearby network entities (e.g., in examples in which the IoT device is within a coverage area of multiple network entities) or with other data tones sent by the network entity (e.g., for other types of communication, such as enhanced mobile broadband (eMBB)). In this example, each network entity may select a respective, different data tone that, together with the helper tone, may be used to filter the data tones using envelope detection.

In some examples, the WET device may acquire frequency and time synchronization information from the network entity (e.g., via an ambient IoT synchronization signal block (SSB)) and may synchronize transmission of the CW signal and other CW signals from other WETs using the frequency and time synchronization information. In some examples, the network entity may further include helper tone information within a primary synchronization signal (PSS) of the ambient IoT SSB. For example, the helper tone information may correspond to one or more bits of the PSS. The helper tone information may include, for example, an indication of the helper tone, an indication of the data tone, and/or a schedule for transmission of CW signals.

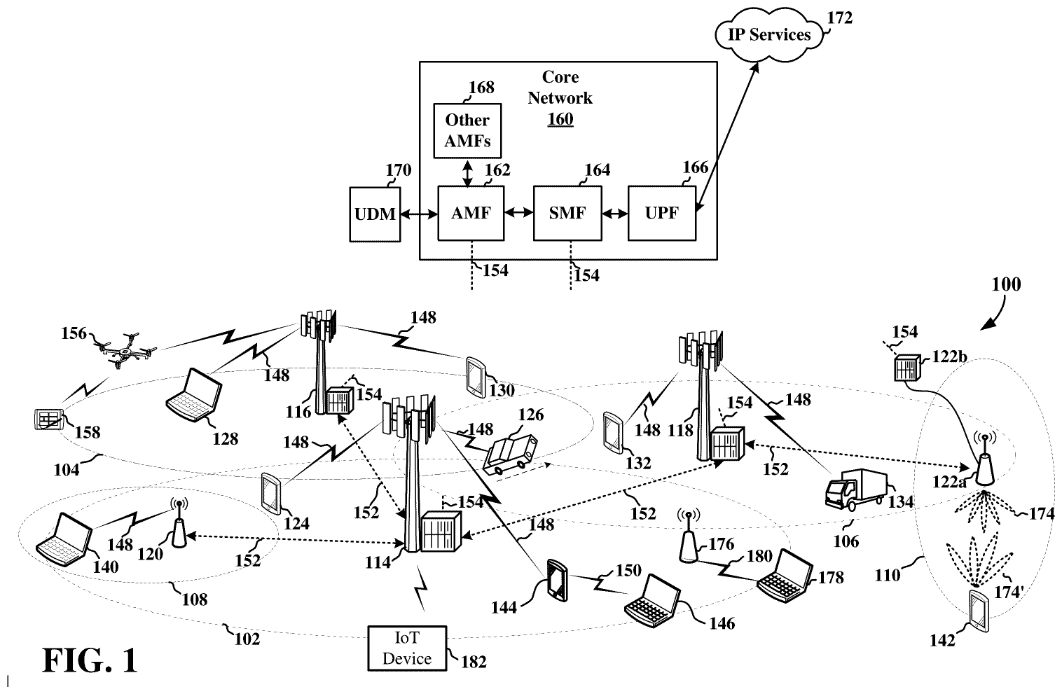

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3rd Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

In some examples, a UE may correspond to an IoT device 182. The IoT device 182 may include, for example, a passive IoT device, such as RFID-type sensor/actuator (SA), a semi-passive IoT device, or an active IoT device. Active IoT devices and semi-active IoT device may include a battery or power source that may be charged, for example, using wireless power transfer (WPT) or, more generally, ambient energy harvesting, whereas passive IoT devices lack an internal power source, and therefore, use ambient energy harvesting to power the device. Semi-passive IoT devices may include a capacitor or other storage device that provides a warm start-up to the energy harvesting in the device. The IoT device 182 may communicate with a network entity (e.g., network entity 114 or RFID reader). In some examples, the network entity 114 may communicate with the IoT device via cellular (Uu) links. For example, the network entity 114 may provide an energy transmission on the downlink to power the IoT device. The energy transmission may further be modulated and backscattered by the IoT device 182 as an information-bearing signal on the uplink. In addition, the network entity 114 may transmit control information and/or data to the IoT device 182 on the downlink, which may be detected by the IoT device using, for example, envelope detection. In this manner, the network entity 114 may read information from the IoT device 182 and write information to the IoT device 182.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

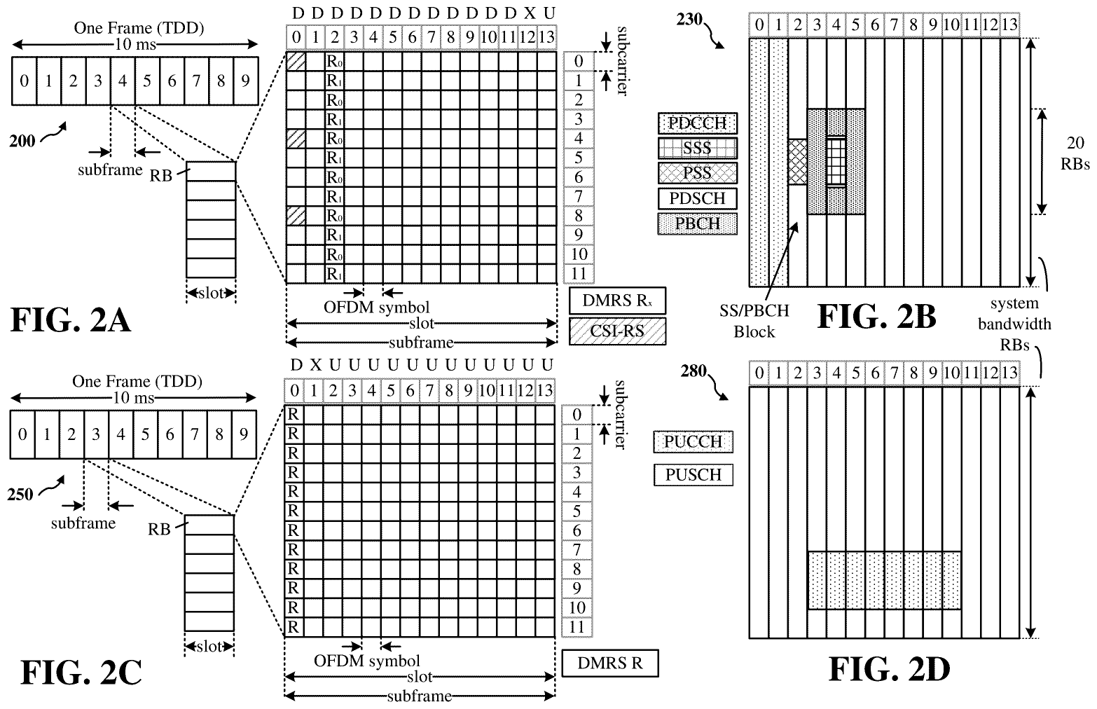

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

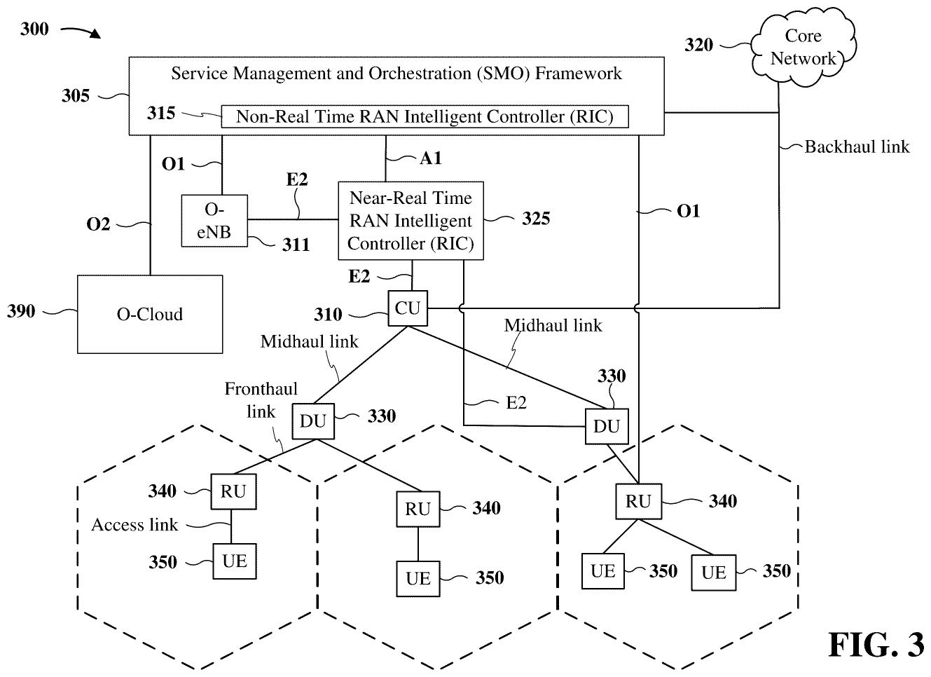

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E3 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O3 interface). Such virtualized network elements can include, but are not limited to, CUs 310, DUs 330, RUs 340 and Near-RT RICs 325. In some implementations, the SMO Framework 305 can communicate with a hardware aspect of a 5G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E3 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

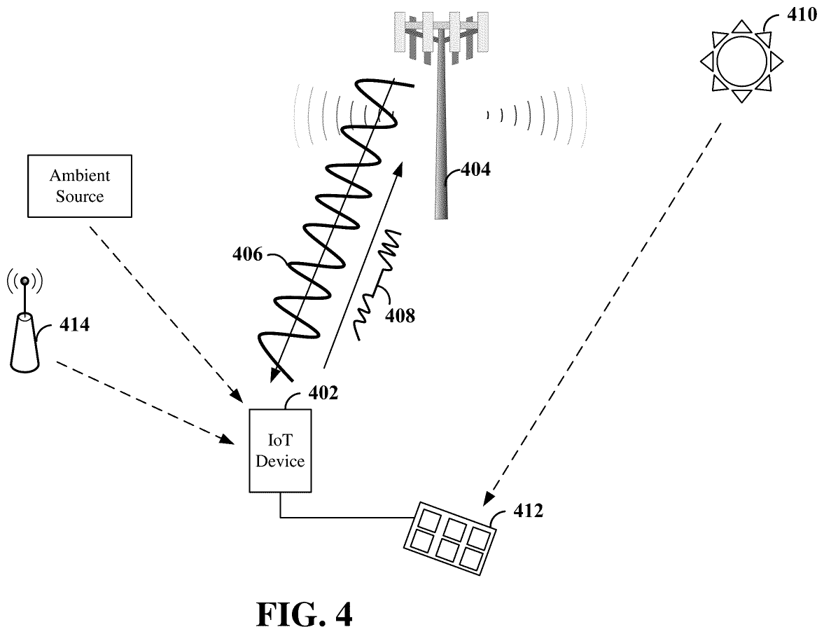

FIG. 4 illustrates an example of ambient IoT communication according to some aspects. In the example shown in FIG. 4, an ambient IoT device 402 is in communication with a network entity 404 (e.g., reader or gNB, the latter being illustrated). The IoT device 402 may be, for example, a passive IoT device, such as RFID-type sensor/actuator (SA), an active IoT device, or a semi-active IoT device. The network entity 404 and IoT device 402 may utilize cellular (Uu) links for both wireless power transfer (WPT) and communication (e.g., downlink and/or uplink control and/or data information). For example, the network entity 404 may provide an energy transmission 406 that may be received by the IoT device 402. The energy transmission 406 may correspond to a waveform, such as a single-tone sinusoidal continuous wave (CW) signal or other suitable waveform. The energy transmission (e.g., CW signal) 406 may provide power to the transmit/receive circuitry or other energy harvesting circuitry within the IoT device 402. The IoT device 402 may be configured to backscatter and modulate at least a fraction of the CW signal 406 to enable an information-bearing signal 408 (e.g., backscattered signal) to be reflected from the IoT device 402 towards the network entity 404.

The network entity 404 may receive the backscattered signal 408 and decode the information included in the backscattered signal 408. However, the network entity 404 may experience self-interference of the backscattered signal 408 as a result of the simultaneous transmission of the CW signal 406. That is, a portion of the CW signal 406 may leak into the backscattered signal 408, thus resulting in self-interference between the CW signal 406 and the backscattered signal 408. As a result, the network entity 404 and IoT device 402 may employ various self-interference cancellation techniques to mitigate the self-interference experienced by the network entity 404. For example, the IoT device 402 may apply a frequency shift to the backscattered signal 408 to provide a frequency separation between the CW signal 406 and the backscattered signal 408 to aid in decoding of the backscattered signal 408.

In addition to CW WPT signals, the network entity 404 may further provide downlink control and/or data to the IoT device 402. In some examples, the IoT device 402 may utilize envelope detection (e.g., amplitude demodulation) to receive a downlink communication (e.g., control information and/or data) sent from network entity 404 to the IoT device 402. Envelope detection is a process that extracts the envelope (e.g., amplitude variation) of a modulated signal to demodulate and retrieve the information included in the modulated signal without performing further RF processing on the modulated signal.

In some examples, the ambient IoT device 402 may further be configured to harvest energy from other ambient energy sources, such as solar energy 410 with the use of a coupled solar panel 412, wireless energy transmitter devices 414 (e.g., devices that transmit CW signals or other suitable waveforms for WPT), and/or other ambient energy sources 416, such as television transmission sources, other RF signal sources, or other types of energy sources (e.g., heat, vibration, etc.).

Wireless energy transmitter (WET) devices 414 may be deployed to enhance the range of WPT. For example, to initiate energy harvesting (WPT) at an ambient IoT device 402, a receive power of −20 dBm for passive IoT devices and −35 dBm for semi-passive IoT devices may be needed. However, the receive power of signals from network entities 404 may be much lower (e.g., −65 dBm or lower). This may be due, for example, to the placement of network entities (e.g., gNBs) at large distances from IoT devices. For example, network entities may be placed at locations that achieve the desired communication requirements of the network based on various interference management techniques, which can result in a lower received power at the IoT device than needed for energy harvesting. By deploying WET devices 414 at a reduced distance from IoT devices 402, as compared to network entity devices (e.g., gNBs) 404, the received power at IoT devices 402 may be increased, thus meeting WPT requirements for IoT energy harvesting. In addition, due to the low complexity and reduced processing capability of WET devices 414, the cost of WET deployment can be minimized. For example, a WET device 414 may not be configured for connectivity, and therefore, may not include any additional processing capability other than CW signal generation and transmission. In other examples, a WET device 414 may include minimal processing capability (e.g., the WET device may include an RFID tag or similar functionality). Furthermore, WETs may be deployed in indoor settings (e.g., retail settings or factory environments), where electrical outlets for powering the WET devices are readily accessible.

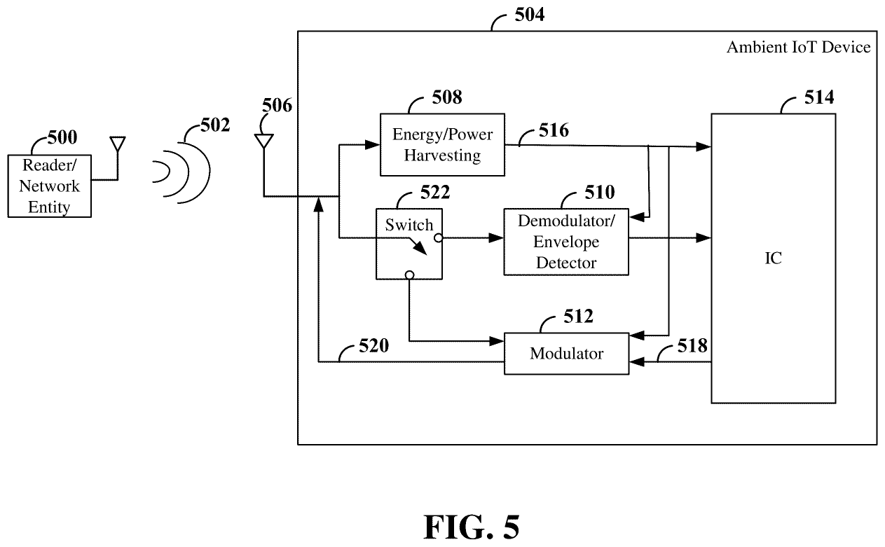

FIG. 5 is a diagram illustrating an example of a passive IoT device according to some aspects. In the example shown in FIG. 5, a transmitting (Tx) device 500, such as a network entity or RFID reader, transmits an RF signal 502 (e.g., a CW signal) to a receiving (Rx) device 504, such as an ambient IoT device. The ambient IoT device 504 may be, for example, a passive IoT device that lacks a battery or power source.

Once the RF signal 502 reaches the passive IoT device 504, the energy from the RF signal 502 travels through an antenna 506 on the passive IoT device 504 and is harvested via an energy/power harvesting circuit 508 that activates (supplies power to) other components of the passive IoT device 504. For example, the energy harvesting circuit 508 may supply power 516 to a demodulator/envelope detector 510, a modulator 512, and one or more other integrated circuits (ICs) 514, which may include, for example, one or more processors and/or one or more memories. In some examples, the IC 514, demodulator 510 and modulator 512 may be included within a microcontroller, microchip, or other suitable processing system on the passive IoT device 504. In some examples, the energy harvesting circuit 508 may include an internal antenna coil that is energized via electromagnetic induction.

The demodulator/envelope detector 510 may be configured to detect an envelope of the RF signal 502 to extract the information (e.g., downlink control and/or data) from the RF signal 502. In some examples, the extracted information may be provided to the IC 514 for further processing or storage. The modulator 512 may be configured to backscatter and modulate remaining energy from the RF signal 502 and to transmit the backscattered and modulated signal 520 to the network entity/reader 500 via the antenna 506. For example, the IC 514 may provide information bits 518 to the modulator 512 for modulation of the backscattered signal with the information bits 518 to produce the backscattered and modulated signal 520. In some examples, backscattering (reflection) may be based on a mismatch between the antenna 506 and a load impedance of the modulator 512. By varying the load impedance of the modulator 512, the reflection coefficient may vary according to a random sequence that modulates the backscattered signal with the information bits 518. The passive IoT device 504 may further include a switch 522 configured to switch between downlink communication (e.g., to receive and detect an envelope of an RF signal carrying downlink control and/or data) and uplink communication (e.g., to modulate and backscatter the RF signal).

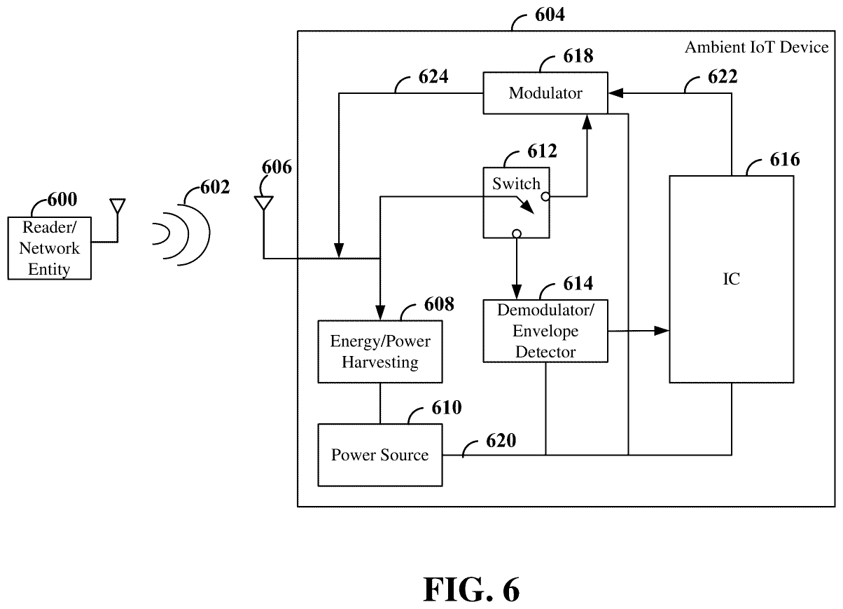

FIG. 6 is a diagram illustrating an example of an active IoT device with energy harvesting according to some aspects. In the example shown in FIG. 6, a transmitting (Tx) device 600, such as a network entity or RFID reader, transmits an RF signal 602 (e.g., a CW signal) to a receiving (Rx) device 604, such as an ambient IoT device. The ambient IoT device 604 may be, for example, an active IoT device that includes a battery or power source 610.

Once the RF signal 602 reaches the active IoT device 604, the energy from the RF signal 602 travels through an antenna 606 on the active IoT device 604 and is harvested via an energy/power harvesting circuit 608 to charge the power source 610. In some examples, the energy harvesting circuit 608 includes an impedance matching network and a rectifier/voltage multiplier configured to receive the RF signal 602 and convert the RF signal 602 into a direct current (DC) signal (e.g., output power 620) to charge the power source 610. The power source 610 may then supply power 620 to a demodulator/envelope detector 614, a modulator 618, and one or more other integrated circuits (ICs) 616, which may include, for example, one or more processors and/or one or more memories. In some examples, the IC 616, demodulator 614 and modulator 618 may be included within a microcontroller, microchip, or other suitable processing system on the active IoT device 604.

The demodulator/envelope detector 614 may be configured to detect an envelope of the RF signal 602 to extract the information (e.g., downlink control and/or data) from the RF signal 602. In some examples, the extracted information may be provided to the IC 616 for further processing or storage. The modulator 618 may be configured to backscatter and modulate remaining energy from the RF signal 602 and to transmit the backscattered and modulated signal 624 to the network entity/reader 600 via the antenna 606. For example, the IC 616 may provide information bits 622 to the modulator 618 for modulation of the backscattered signal with the information bits 622 to produce the backscattered and modulated signal 624. In some examples, backscattering (reflection) may be based on a mismatch between the antenna 606 and a load impedance of the modulator 618. By varying the load impedance of the modulator 618, the reflection coefficient may vary according to a random sequence that modulates the backscattered signal with the information bits 622. The active IoT device 604 may further include a switch 612 configured to switch between downlink communication (e.g., to receive and detect an envelope of an RF signal carrying downlink control and/or data) and uplink communication (e.g., to modulate and backscatter the RF signal).

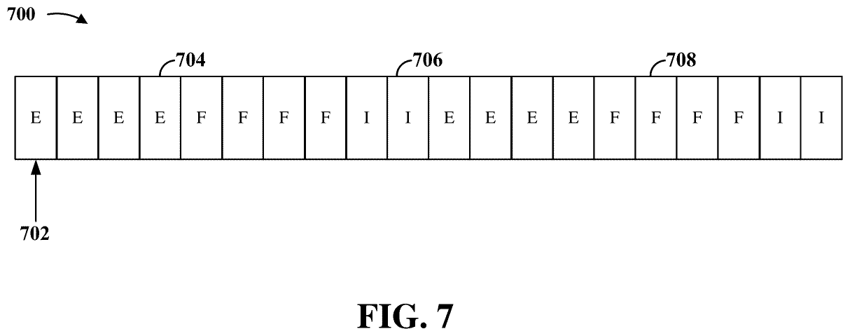

To facilitate communication of downlink and/or uplink control information and/or data between the network entity/reader and the IoT device, an ambient IoT slot format may be utilized. FIG. 7 is a diagram illustrating an example of an ambient IoT slot format according to some aspects. In the example shown in FIG. 7, the ambient IoT slot format indicates slots 702 used for energy transfer (E) 704 and slots used for information transfer (I) 706. Energy transfer (E) slots 704 may be used solely for WPT from the network entity to the IoT device (e.g., transmission of CW signals from the network entity to the IoT device) without communication of downlink and/or uplink information. Information transfer (I) slots 706 may include, for example, both downlink slots for downlink communication from the network entity to the IoT device and uplink slots for uplink communication from the IoT device to the network entity. During uplink slots, the network entity may transmit CW signals to the IoT device for modulation and backscattering of the CW signals to the network entity. In addition, one or more of the slots 702 may be considered to be flexible (F) slots 708 that may be used for either energy transfer or information transfer.

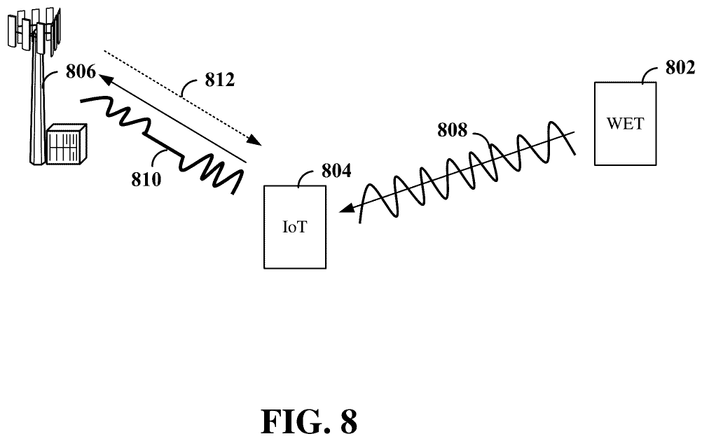

In various aspects, WET devices may be used to aid in communication between an IoT device and a network entity. FIG. 8 is a diagram illustrating an example of WET-assisted uplink transmission from an ambient IoT device 804 to a network entity 806, according to some aspects. The ambient IoT device 804 may be, for example, an active, passive, or semi-passive IoT device. The network entity 806 may be, for example, an RFID reader or base station (e.g., gNB), the latter being illustrated.

In the example shown in FIG. 8, a WET device is configured to transmit a CW signal 808 to the IoT device 804. The CW signal 808 enables wireless power transfer (WPT) to the IoT device 804. For example, the IoT device may receive the CW signal 808 and initiate energy harvesting of the CW signal 808 to supply power to an internal battery (e.g., for an active IoT device) or to directly power other circuitry (e.g., modulation/demodulation circuitry and/or one or more other processing devices and/or memories of a passive IoT device).

In addition, the IoT device 804 may be configured to backscatter and modulate the CW signal to produce a modulated CW signal 810 (e.g., an uplink transmission) that is transmitted to the network entity. For example, the IoT device 804 may modulate the backscattered CW signal with one or more information bits representing information to be transmitted to the network entity 806. Since WPT may require a higher receive power (e.g., −20 dBm/−35 dBm for active/passive IoT) than the receive power (e.g., −65 dBm) of RF signals sent from the network entity, the WET device 802 may provide an improved forward-link quality for backscattering by the IoT device 804, which in turn improves the reverse-link (uplink) quality of the modulated CW signal. Moreover, as the network entity 806 no longer needs to simultaneously transmit CW signals and receive backscattered and modulated CW signals during uplink slots, the network entity 806 may not need to employ self-interference cancellation techniques to process the modulated CW signal.

The arrangement shown in FIG. 8 may correspond to a bi-static communication configuration in which the IoT device 804 receives the CW signal 808 from a first device (e.g., the WET device 802) and transmits the modulated CW signal 810 to a second device (e.g., a network entity 806) that is separate from the first device (e.g., separate in location/position and separate in type of device). This arrangement can be differentiated from a mono-static communication configuration, such as that shown in FIG. 4, in which the network entity 806 both transmits the CW signal to the IoT device 804 and receives the backscattered and modulated CW signal from the IoT device 804.

Due to the increased separation between the transmit and receive antennas in the bi-static communication configuration, the IoT device 804 may apply a smaller frequency shift than that needed in the mono-static communication configuration. In some examples, as shown in FIG. 8, the network entity 806 may provide a frequency shift indication 812 to the IoT device 804. The frequency shift indication 812 may indicate the frequency shift to be applied to the CW signal 808. The IoT device 804 may then apply the indicated frequency shift to the CW signal to produce the modulated CW signal 810 at a shifted frequency with respect to the frequency of the CW signal 808. For example, the frequency shift indication 812 may indicate a frequency shift that is less than a mono-static frequency shift applied to other signals (e.g., other CW signals) from the network entity 806 that may be backscattered by the IoT device 804.

In some examples, the CW signal 808 sent from the WET device 802 to the IoT device 804 may be configured to prevent interference with downlink transmissions (e.g., downlink control and/or data transmissions) from the network entity 806 to the IoT device 804. This may be realized in various manners. For example, the WET device 802 may avoid transmission of the CW signal 808 in downlink slots by implementing time division multiplexing of the CW signal 808 and downlink transmission from the network entity 806. As another example, the WET device 802 may transmit the CW signal 808 on a different frequency band than downlink transmission from the network entity 806 by implementing frequency division multiplexing of the CW signal 808 and downlink transmission from the network entity 806. As yet another example, the WET device 802 may transmit the CW signal 808 on a helper tone separated in frequency from a data tone of the downlink transmission. The helper tone may be within the same frequency band as the data tone and may aid in envelope detection of the data tone.

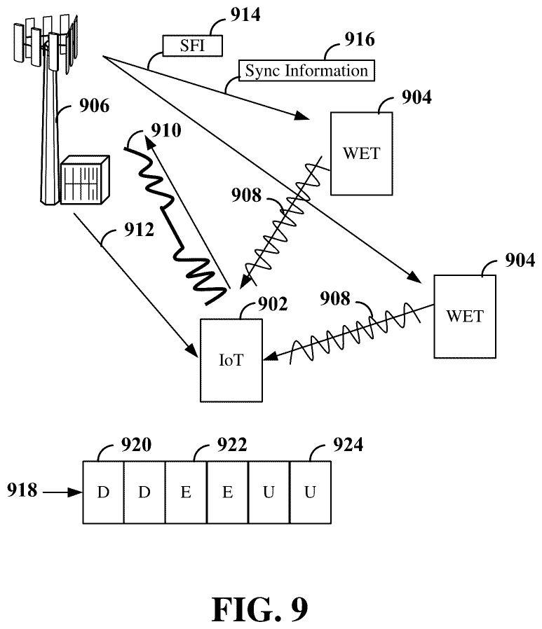

FIG. 9 is a diagram illustrating an example of time-division multiplexing of downlink transmissions and CW signals according to some aspects. In the example shown in FIG. 9, an ambient IoT device 902 is configured to receive a CW signal 908 from one or more WET devices 904 and to backscatter and modulate the CW signal to produce a modulated CW signal 910 that may be transmitted to a network entity 906. The ambient IoT device 902 may be, for example, an active, passive, or semi-passive IoT device. The network entity 906 may be, for example, an RFID reader or base station (e.g., gNB), the latter being illustrated.

The ambient IoT device 902 may be configured to backscatter and modulate the CW signal 908 within one or more uplink slots 924 of an ambient IoT slot format 918. In addition, the network entity 906 may be configured to provide a downlink transmission 912 to the IoT device 902 within one or more downlink slots 920 of the ambient IoT slot format 918. The downlink transmission 912 may include, for example, downlink control information and/or downlink data.

In some WET device configurations, the WET device(s) 904 may be configured to transmit respective CW signal(s) 908 continuously, including within uplink slots 924, downlink slots 920 and energy slots 922. However, due to the potentially high receive power of the CW signal 908, the CW signal 908 may interfere with the downlink transmission 912 from the network entity 906. Therefore, in various aspects, the network entity 906 may provide a slot format indicator (SFI) indicating the ambient IoT slot format 918 to the WET device(s) 904. The SFI may be provided, for example, within a system information block (SIB) sent by the network entity 906. Thus, in this example, the WET device(s) 904 may be configured to decode a master information block (MIB) within a physical broadcast control channel (PBCH) of a synchronization signal block (SSB) sent by the network device 906 to further receive the SIB containing the SFI from the network device 906. Based on the SFI 914, the WET device(s) 904 can identify the ambient IoT downlink slots 920, uplink slots 924, and energy slots 922. The WET device(s) 904 may then be configured to transmit the CW signal 908 within energy slots 922 and uplink slots 924, but avoid transmitting the CW signal 908 within downlink slots 920. In this manner, the CW signals 908 are time-division multiplexed with downlink transmission 912.

In some examples, the network entity 906 may further provide synchronization information 916 (e.g., frequency and time synchronization information) to the WET device(s) 904. For example, the synchronization information 916 may correspond to an SSB sent by the network entity 904. The WET device(s) 904 may utilize the synchronization information 916 to synchronize transmission of their respective CW signals 908. In some examples, the WET devices 904 may apply sequence matching, which may be less complex than full data synchronization since the CW signals 908 may not require tight phase alignment. By synchronizing the CW signals 908, interference/cancellation between the CW signals 908 may be minimized.

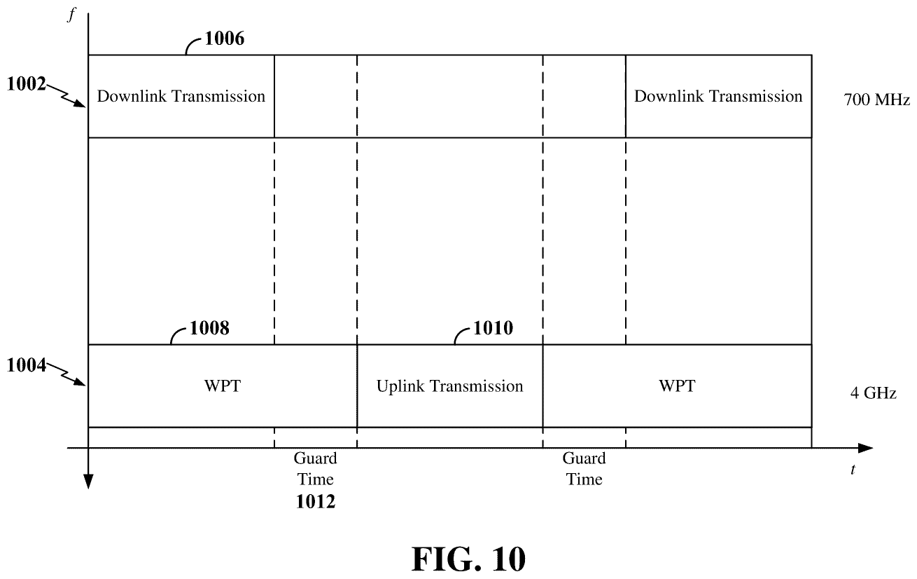

FIG. 10 is a graph illustrating an example of frequency-division multiplexing of downlink transmissions and CW signals according to some aspects. In the example shown in FIG. 10, time is illustrated along the horizontal axis, while frequency is illustrated along the vertical axis. Along the frequency axis, two different frequency bands 1002 and 1004 are shown. A first frequency band 1002 may correspond to a 700 MHz frequency band, while a second frequency band 1004 may correspond to a 4 GHz frequency band. Downlink transmissions 1006 from a network entity to an ambient IoT device may occur in the first frequency band 1002. In addition, to avoid interference with the downlink transmissions 1006, wireless power transfer (WPT) continuous wave (CW) signals 1008 may be transmitted from one or more WET devices to the ambient IoT device in the second frequency band 1004. Thus, the CW signals 1008 are transmitted in a higher frequency band (e.g., 4 GHZ) than downlink transmissions (e.g., 700 MHz). The ambient IoT device may then backscatter and modulate the CW signals 1008 to produce uplink transmissions 1010 in the second frequency band 1004 that are sent from the ambient IoT device to the network entity.

The frequency-division multiplexing approach reduces the complexity of WET devices as compared to the time-division multiplexing approach by enabling WET devices to continuously transmit CW signals 1008 without regard for the slot format utilized by the network entity (e.g., the WET devices do not need to decode the SFI). In some examples, the WET devices may still acquire frequency and time synchronization information from the network entity to synchronize transmission of CW signals among the WET devices. However, by transmitting CW signals in the upper band, the WPT range may be reduced, which may result in lower forward-link quality, thus, reducing the reverse-link quality of the uplink transmissions 1010.

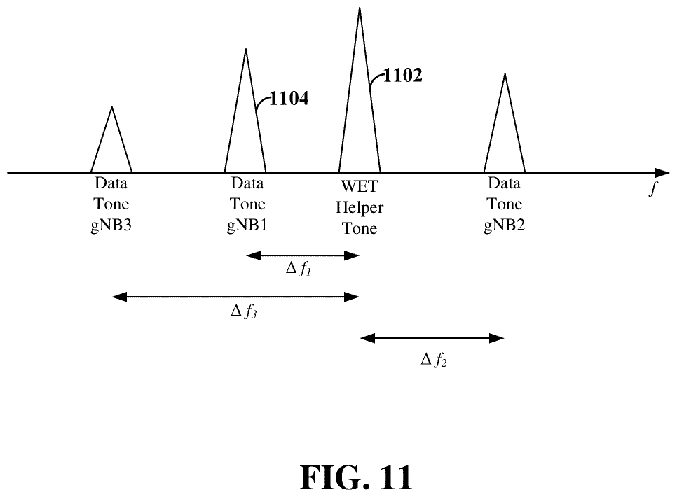

FIG. 11 is a diagram illustrating an example of helper tone CW transmissions according to some aspects. In the example shown in FIG. 11, a WET device may transmit a CW signal on a helper tone 1102 (e.g., a first frequency). In addition, each of a plurality of neighboring network entities (e.g., RFID readers and/or gNBs) may transmit an RF signal (e.g., a CW signal) on a respective data tone 1104. The helper tone 1102, together with a corresponding data tone 1104, aids in reducing interference at the IoT device with envelope detection. For example, an ambient IoT device may not be able to distinguish between the RF signals (e.g., carrier frequencies or data tones) from different network entities or from the same network entity transmitting, for example, eMBB signals in addition to ambient IoT signals, using envelope detection. Therefore, adding a helper tone 1102 may assist in filtering out the other carrier frequencies.

The helper tone 1102 may differ from each of the data tones 1104 by a respective frequency difference (e.g., Δf). For example, the helper tone 1102 may differ in frequency from the data tone 1104 of a first network entity (gNB1) by Δf₁, the helper tone 1102 may differ in frequency from the data tone 1104 of a second network entity (gNB2) by Δf₂, and the helper tone 1102 may differ in frequency from the data tone 1104 of a third network entity (gNB3) by Δf₃. In some examples, each of the network entities (e.g., gNB1, gNB2, and gNB3) may select a different Δf separation from the helper tone 1102. For example, the helper tone 1102 may be pre-configured based the region in which the WET device is deployed (e.g., the frequency bands available in the region) and the network entities can coordinate to select a different Δf from the pre-configured helper tone 1102. In other examples, the WET device may select the helper tone 1102 based on the respective data tones of the nearby network entities and/or may be configured with the helper tone 1102 by one or more of the network entities (e.g., gNB1 may provide the helper tone 1102 or a list of available helper tones to select from to the WET device). In examples in which the WET device selects the helper tone or is pre-configured with a helper tone, the WET device may transmit (e.g., broadcast) the selected helper tone to the neighboring network entities.

By moving the helper tone 1102 away from the near DC-component of each of the data tones 1104 by a respective Δf, the IoT device may be able to decode the information sent on a particular data tone (e.g., the data tone of gNB1) using envelope detection in the presence of other interfering data tones (e.g., the data tones of gNB2 and gNB3) with limited additional processing. For example, the IoT device may perform near-baseband Δf filtering (e.g., to filter out other carrier frequencies/data tones at baseband) without requiring additional RF processing to decode the information sent on a desired data tone 1104 (e.g., the data tone of gNB1). This process is effective in reducing interference between data tones 1104 for a small number of resource blocks (RBs). In some examples, a power spectral density (PSD) boost may be applied by the transmitting network entity (e.g., gNB1) with larger bandwidth interference (e.g., co-source transmissions over 20 MHz) to meet the carrier to interference plus noise (CINR) requirements of envelope detection.

WET devices may transmit CW signals on helper tones 1102 without regard for the ambient IoT slot format. Thus, WET devices may transmit on helper tones 1102 during energy slots, downlink slots, and uplink slots. As a result, WET devices WET devices do not need to decode the SFI from network entities, thereby reducing the complexity of WET devices. In some examples, the WET devices may still acquire frequency and time synchronization information from the network entities to synchronize transmission of CW signals among the WET devices.

WET devices may further operate in dual-band mode in which WET devices can transmit a CW signal on both the lower and upper bands, as shown in FIG. 10. For example, a WET device may transmit a first CW signal on the helper tone in the lower band 1002 and also transmit a second CW signal on the upper band 1004. In this example, an IoT device performing envelope detection using the helper tone can backscatter and modulate the combined CW signal (e.g., combination of the CW signal on the helper tone 1102 and the CW signal on the data tone 1104) in the lower band. In addition, another IoT device performing envelope detection on the upper band may utilize the CW signal on the upper band for backscattering and modulation thereof.

In some examples, the network entities (e.g., gNB1) may provide helper tone information to the WET devices to assist the WET devices in transmitting on the helper tone. In some examples, the helper tone information may be sent within an ambient IoT SSB (e.g., a Primary Synchronization Signal (PSS) of the SSB).

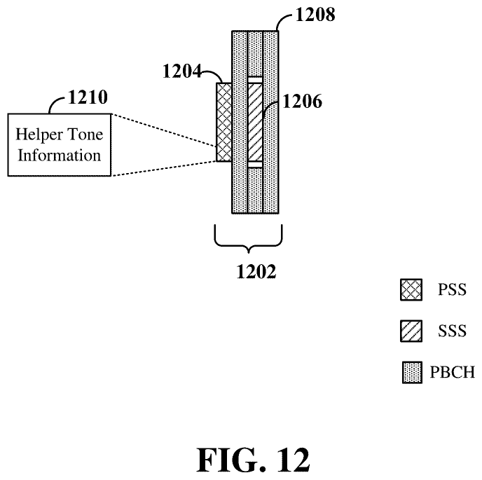

FIG. 12 is a diagram illustrating an example of an ambient IoT synchronization signal block (SSB) according to some aspects. The SSB 1202 includes a PSS 1204, a SSS 1206, and a PBCH 1208. The PSS 1204 may include a PSS sequence selected from a set of PSS sequences. In addition, the SSS 1206 may include a SSS sequence selected from a set of SSS sequences. In some examples, the PSS/SSS sequences provide cell identification information for the network entity. The PBCH 1208 includes the MIB carrying various system information (SI).

In the example shown in FIG. 12, the SSB 1202 may be configured with PSS sequence-space partitioning to convey helper tone information 1210 to the WET device. For example, the helper tone information 1210 may be conveyed within one or more bits of the PSS 1204. In some examples, the helper tone information 1210 may include at least one of an indication of the helper tone, an indication of the data tone of the network entity, or power information associated with the CW signal sent on the helper tone. For example, the power information may include a schedule for transmission of the CW signal.

In some examples, the SSB 1202 may correspond to a lean SSB that uses less bandwidth and resources than, for example, an eMBB SSB that may consume 20 RBs. For example, a lean SSB may include 12 RBs. In addition, the SSB 1202 shown in FIG. 12 spans four OFDM symbols, however, in some examples, a lean SSB may further occupy fewer than four OFDM symbols. In some examples, a lean SSB may not include an SSS. Various SSB designs are contemplated and the disclosure is not limited to the particular SSB designs described herein.

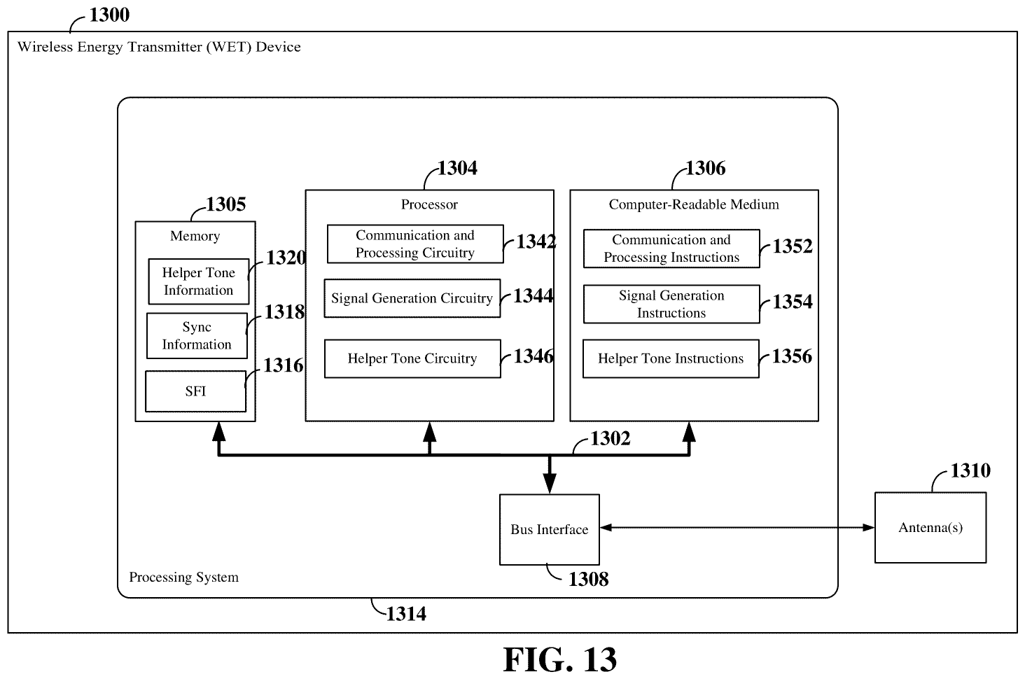

FIG. 13 is a block diagram illustrating an example of a hardware implementation for a wireless energy transmitter (WET) device employing a processing system 1314. For example, the WET device 1300 may correspond to any of the WET devices shown and described above in reference to FIGS. 4, 8, and/or 9.

The WET device 1300 may be implemented with a processing system 1314 that includes one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the WET device 1300 may be configured to perform any one or more of the functions described herein. That is, the processor 1304, as utilized in the WET device 1300, may be used to implement any one or more of the processes and procedures described below.

The processor 1304 may in some instances be implemented via a baseband or modem chip and in other implementations, the processor 1304 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 links together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further. A bus interface 1308 provides an interface between the bus 1302 and at least one antenna 1310. The antenna 1310 provides a means for communicating with various other apparatus over a transmission medium (e.g., air interface).

The processor 1304 is responsible for managing the bus 1302 and general processing, including the execution of software stored on the computer-readable medium 1306. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1304, causes the processing system 1314 to perform the various functions described below for any particular apparatus. The computer-readable medium 1306 and the memory 1305 may also be used for storing data that is utilized by the processor 1304 when executing software. For example, the memory 1305 may store one or more of a slot format indicator (SFI) 1316, synchronization (sync) information 1318, and/or helper tone information 1320.

The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. In some examples, the computer-readable medium 1306 may be part of the memory 1305. Those skilled in the art will recognize how best to implement the described functionality presented throughout this disclosure depending on the particular application and the overall design constraints imposed on the overall system.

In some aspects of the disclosure, the processor 1304 may include circuitry configured for various functions. For example, the processor 1304 may include communication and processing circuitry 1342, configured to communicate with a network entity (e.g., an RFID reader or an aggregated or disaggregated base station, such as a gNB or eNB). In some examples, the communication and processing circuitry 1342 may include one or more hardware components that provide the physical structure that performs processes related to wireless communication (e.g., signal reception and/or signal transmission) and signal processing (e.g., processing a received signal and/or processing a signal for transmission). In some examples, the communication and processing circuitry 1304 may include low complexity circuitry for baseband or near-baseband processing with minimal RF processing.

In some implementations where the communication involves receiving information, the communication and processing circuitry 1342 may receive a signal from a component of the WET device 1300 (e.g., from the antenna 1310 that receives the information via radio frequency signaling or some other type of signaling suitable for the applicable communication medium), process (e.g., decode) the information, and output the processed information. For example, the communication and processing circuitry 1342 may output the information to another component of the processor 1304, to the memory 1305, or to the bus interface 1308. In some examples, the communication and processing circuitry 1342 may receive one or more of signals, messages, other information, or any combination thereof. In some examples, the communication and processing circuitry 1342 may receive information via one or more channels. In some examples, the communication and processing circuitry 1342 may include functionality for a means for receiving. In some examples, the communication and processing circuitry 1342 may include functionality for a means for processing, including a means for demodulating, a means for decoding, etc.

In some implementations where the communication involves sending (e.g., transmitting) information, the communication and processing circuitry 1342 may obtain information (e.g., from another component of the processor 1304, the memory 1305, or the bus interface 1308), process (e.g., modulate, encode, etc.) the information, and output the processed information. For example, the communication and processing circuitry 1342 may output the information to the antenna 1310 (e.g., that transmits the information via radio frequency signaling or some other type of signaling suitable for the applicable communication medium). In some examples, the communication and processing circuitry 1342 may send one or more of signals, messages, other information, or any combination thereof. In some examples, the communication and processing circuitry 1342 may send information via one or more channels. In some examples, the communication and processing circuitry 1342 may include functionality for a means for sending (e.g., a means for transmitting). In some examples, the communication and processing circuitry 1342 may include functionality for a means for generating, including a means for modulating, a means for encoding, etc.

In some examples, the communication and processing circuitry 1342 may be configured to receive, via the antenna 1310, the SFI 1316, the sync information 1318, and/or the helper tone information 1320 from a network entity, via the antenna 1310. For example, the SFI may identify one or more downlink slots for communication from a network entity to at least one ambient IoT device. The sync information 1318 may include frequency and time information obtained from a network entity. The helper tone information 1320 may include at least one of an indication of the helper tone (or a list of available helper tones), an indication of a data tone of a downlink transmission from a network entity to the at least one ambient IoT device, or power information associated with a continuous wave (CW) signal sent on a helper tone. For example, the power information may include a schedule for transmission of the CW signal. In some examples, the communication and processing circuitry 1342 may be configured to receive a primary synchronization signal including one or more bits containing the helper tone information 1320. The communication and processing circuitry 1342 may further be configured to communicate with a network entity to provide the helper tone information 1320 to one or more network entities. In this example, the helper tone information 1320 may include an indication of a selected helper tone selected by the WET device (e.g., based on a pre-configured helper tone, an indication of the data tone used by the network entity, and/or a list of available helper tones provided by the network entity). The communication and processing circuitry 1342 may further be configured to execute communication and processing instructions (software) 1352 stored in the computer-readable medium 1306 to implement one or more of the functions described herein.

The processor 1304 may further include signal generation circuitry 1344, configured to configure a CW signal to avoid interference with a downlink transmission from a network entity. The signal generation circuitry 1344 may further operate together with the communication and processing circuitry 1342 to transmit the CW signal for wireless power transfer (WPT) to at least one ambient IoT device via the antenna 1310. In some examples, the signal generation circuitry 1344 may be configured to avoid transmission of the CW signal within the one or more downlink slots indicated by the SFI 1316. In some examples, the signal generation circuitry 1344 may be configured to generate and transmit the CW signal within a different frequency band than the downlink transmission. For example, the CW signal may be transmitted within a higher frequency band (e.g., 4 GHZ) than the downlink transmission (e.g., 700 MHz). In some examples, the signal generation circuitry 1344 may be configured to synchronize transmission of the CW signal and other CW signals from other WETs using the sync information 1318. In some examples, the signal generation circuitry 1344 may be configured to transmit the CW signal on a helper tone separated in frequency from a data tone of the downlink transmission. In this example, the helper tone and data tone may be within the same frequency band. In some examples, the signal generation circuitry 1344 may further be configured to both transmit the CW signal on the helper tone frequency and to further generate and transmit an additional CW signal within a higher frequency band than the frequency band on which the CW signal is transmitted. The signal generation circuitry 1344 may further be configured to execute signal generation instructions (software) 1354 stored in the computer-readable medium 1306 to implement one or more of the functions described herein.

The processor 1304 may further include helper tone circuitry 1346, configured to identify a helper tone on which to transmit the CW signal. For example, the helper tone circuitry 1346 may utilize the helper tone information 1320 to identify the helper tone for transmission of the CW signal by the signal generation circuitry 1344. The helper tone circuitry 1346 may further be configured to execute helper tone instructions (software) 1356 stored in the computer-readable medium 1306 to implement one or more of the functions described herein.

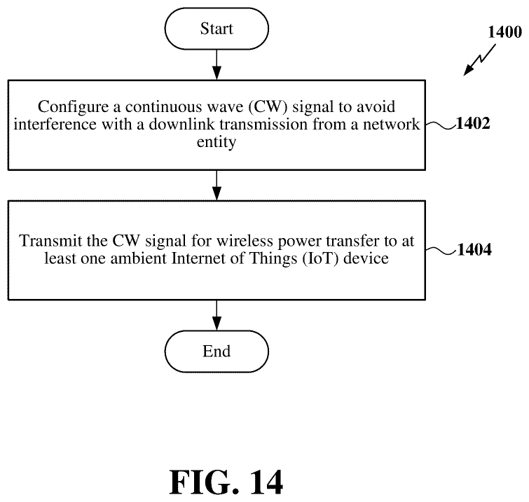

FIG. 14 is a flow chart of an exemplary process 1400 for enhancing communication between network entities and ambient IoT devices using wireless energy transmitter (WET) devices according to some aspects. As described below, some or all illustrated features may be omitted in a particular implementation within the scope of the present disclosure, and some illustrated features may not be required for implementation of all examples. In some examples, the method may be performed by the WET device 1300, as described above and illustrated in FIG. 13, by a processor or processing system, or by any suitable means for carrying out the described functions.

At block 1402, the WET device may configure a continuous wave (CW) signal to avoid interference with a downlink transmission from a network entity. For example, the signal generation circuitry 1344 (and in some examples in combination with the helper tone circuitry 1346), shown and described above in connection with FIG. 13, may provide a means to configure the CW signal.

At block 1404, the WET device may transmit the CW signal for wireless power transfer to at least one ambient Internet of Things (IoT) device. For example, the signal generation circuitry 1344, together with the communication and processing circuitry 1342, and antenna 1310, shown and described above in connection with FIG. 13, may provide a means to transmit the CW signal.

In some examples, the WET device may further receive a slot format indicator (SFI) from the network entity that identifies one or more downlink slots for communication from the network entity to the at least one the ambient IoT device. The WET device may then avoid transmission of the CW signal within the one or more downlink slots.

In some examples, the WET device may transmit the CW signal within a different frequency band than the downlink transmission. For example, the CW signal may be transmitted within a higher frequency band than the downlink transmission.

In some examples, the WET device may acquire frequency and time synchronization information from the network entity and synchronize transmission of the CW signal and other CW signals from other WETs using the frequency and time synchronization information.

In some examples, the WET device may transmit the CW signal on a helper tone separated in frequency from a data tone of the downlink transmission. For example, the WET device may receive helper tone information associated with the CW signal from the network entity. The helper tone information may include at least one of an indication of the helper tone, an indication of the data tone, or power information associated with the CW signal sent on the helper tone. The power information may include, for example, a schedule for transmission of the CW signal. In some examples, the WET device may receive a primary synchronization signal including one or more bits containing the helper tone information. In some examples, the WET device may further transmit an additional CW signal within a higher frequency band than a frequency band on which the CW signal is transmitted.

In one configuration, the WET device 1300 includes means for configuring a continuous wave (CW) signal to avoid interference with a downlink transmission from a network entity and means for transmitting the CW signal for wireless power transfer to at least one ambient Internet of Things (IoT) device, as described in the present disclosure. In one aspect, the aforementioned means may be the processor 1304 shown in FIG. 13 configured to perform the functions recited by the aforementioned means. In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable storage medium 1306, or any other suitable apparatus or means described in any one of the FIGS. 4, 8, 9, and/or 13 utilizing, for example, the processes and/or algorithms described herein in relation to FIG. 14.

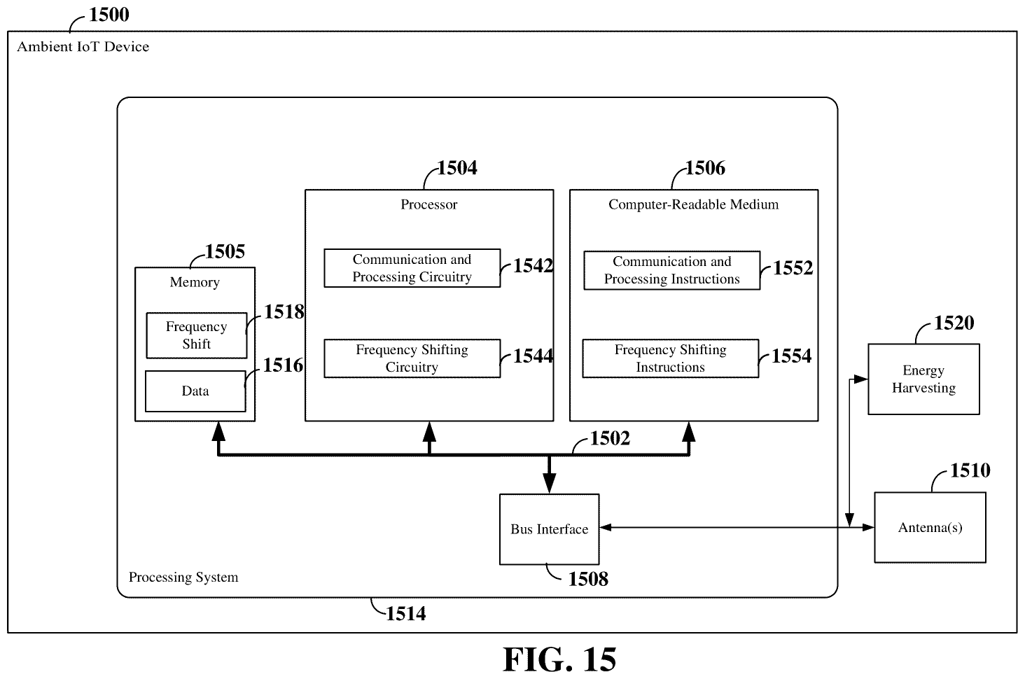

FIG. 15 is a block diagram illustrating an example of a hardware implementation for an ambient Internet of Things (IoT) device employing a processing system 1514. For example, the ambient IoT device 1500 may correspond to any of the IoT devices shown and described above in reference to FIGS. 1, 4, 5, 6, 8, and/or 9, and may include the circuitry shown in any of FIGS. 5 and/or 6.

In accordance with various aspects of the disclosure, an element, or any portion of an element, or any combination of elements may be implemented with a processing system 1514 that includes one or more processors 1504. The processing system 1514 may be substantially the same as the processing system 1314 illustrated in FIG. 13, including a bus interface 1508, a bus 1502, memory 1505, a processor 1504, and a computer-readable medium 1506. Furthermore, the ambient IoT device may include at least one antenna 1510 and an energy harvesting circuit 1520 configured to supply power to the processing system and/or to provide power to a power source (not shown). In some examples, the energy harvesting circuit 2530 may correspond to the energy/power harvesting circuit 508 or 608 shown in FIG. 5 or 6. The processor 1504, as utilized in an ambient IoT device 1500, may be used to implement any one or more of the processes described herein. In some examples, the memory 1505 may store one or more of data 1516 and/or a frequency shift 1518 that may be utilized by the processor 1504 when executing software.

The processor 1504 may include communication and processing circuitry 1542, configured to communicate with a network entity. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). In some examples, the communication and processing circuitry 1542 may include low complexity circuitry, such as envelope detection circuitry.

In some implementations where the communication involves receiving information, the communication and processing circuitry 1542 may receive a downlink transmission from the antenna 1510, process (e.g., demodulate/decode using, for example, envelope detection) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 2742 may obtain information (e.g., from another component of the processor 1504, the memory 1505, or the bus interface 1508), process (e.g., modulate, encode, etc.) the information, and output the processed information. For example, the communication and processing circuitry 1542 may output the information to the antenna 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc. In some examples, the communication and processing circuitry 1542 includes a means for backscattering a CW signal.

The communication and processing circuitry 1542 may further be configured to receive a continuous wave (CW) signal for wireless power transfer from a wireless energy transmitter (WET) device via the antenna 1510. For example, the antenna 1510 may provide the CW signal to the energy harvesting circuit 1520 to power the processing system 1514 and may further provide the CW signal (e.g., a remaining portion of the wave) to the communication and processing circuitry 1542. The communication and processing circuitry 1542 may further be configured to backscatter and modulate at least the CW signal to produce a modulated CW signal. For example, the communication and processing circuitry 1542 may be configured to modulate the backscattered CW signal using the data 1516 (e.g., information bits) stored in the memory 1505. The communication and processing circuitry 1542 may further be configured to transmit the modulated CW signal to a network entity separate from the WET device.

In some examples, the communication and processing circuitry 1542 may further be configured to receive a downlink transmission from the network entity. In some examples, the CW signal is received in a different frequency band than the downlink transmission. For example, the CW signal may be received in a higher frequency band than the downlink transmission.

In some examples, the communication and processing circuitry 1542 may be configured to receive a downlink transmission from the network entity on a data tone separated in frequency from a helper tone carrying the CW signal. The communication and processing circuitry 1542 may further be configured to apply envelope detection to the downlink transmission using the data tone and the helper tone.

In some examples, the communication and processing circuitry 1542 may include the modulator/demodulator shown in any of FIGS. 5 and/or 6. The communication and processing circuitry 1542 may further be configured to execute communication and processing instructions (software) 1552 stored in the computer-readable medium 1506 to implement one or more of the functions described herein.

The processor may further include frequency shifting circuitry 1544, configured to receive a frequency shift indication from the network entity that indicates a frequency shift to be applied to the CW signal. The frequency shifting circuitry 1544 may further be configured to operate together with the communication and processing circuitry 1542 to apply the frequency shift to the CW signal to produce the modulated CW signal at a shifted frequency. In some examples, the frequency shift is less than a mono-static frequency shift applied to other signals from the network entity backscattered by the ambient IoT device. The frequency shifting circuitry 1544 may further be configured to execute frequency shifting instructions (software) 1554 stored in the computer-readable medium 1506 to implement one or more of the functions described herein.

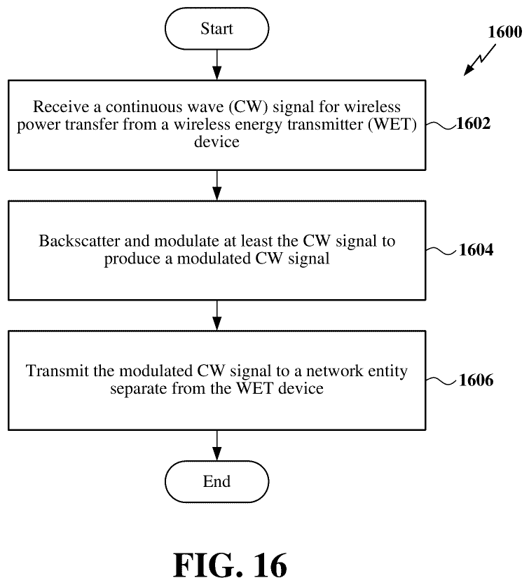

FIG. 16 is a flow chart of another exemplary process 1600 for enhancing communication between network entities and ambient IoT devices using wireless energy transmitter (WET) devices according to some aspects. As described below, some or all illustrated features may be omitted in a particular implementation within the scope of the present disclosure, and some illustrated features may not be required for implementation of all examples. In some examples, the method may be performed by the ambient IoT device 1500, as described above and illustrated in FIG. 15, by a processor or processing system, or by any suitable means for carrying out the described functions.

At block 1602, the ambient IoT device may receive a continuous wave (CW) signal for wireless power transfer from a wireless energy transmitter (WET) device. For example, the communication and processing circuitry 1542 together with the antenna 1510, shown and described above in connection with FIG. 15, may provide a means to receive the CW signal.

At block 1604, the ambient IoT device may backscatter and modulate at least the CW signal to produce a modulated CW signal. For example, the communication and processing circuitry 1542 (in some examples together with the frequency shifting circuitry 1544), shown and described above in connection with FIG. 15, may provide a means to backscatter and modulate the CW signal.

At block 1606, the ambient IoT device may transmit the modulated CW signal to a network entity separate from the WET device. For example, the communication and processing circuitry together with the antenna 1510, may provide a means to transmit the modulated CW signal.

In some examples, the ambient IoT device may further receive a frequency shift indication from the network entity that indicates a frequency shift to be applied to the CW signal. The ambient IoT device may further apply the frequency shift to the CW signal to produce the modulated CW signal at a shifted frequency. In some examples, the frequency shift is less than a mono-static frequency shift applied to other signals from the network entity that are backscattered by the ambient IoT device.

In some examples, the ambient IoT device may receive a downlink transmission from the network entity. In this example, the CW signal may be received in a different frequency band than the downlink transmission. For example, the CW signal may be received in a higher frequency band than the downlink transmission.

In some examples, the ambient IoT device may receive a downlink transmission from the network entity on a data tone separated in frequency from a helper tone carrying the CW signal. The ambient IoT device may further apply envelope detection to the downlink transmission using the data tone and the helper tone.

In one configuration, the IoT device 1500 includes means for receiving a continuous wave (CW) signal for wireless power transfer from a wireless energy transmitter (WET) device, means for backscattering and modulating at least the CW signal to produce a modulated CW signal, and means for transmitting the modulated CW signal to a network entity separate from the WET device, as described in the present disclosure. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 4-6, 8, 9, and/or 15 utilizing, for example, the processes and/or algorithms described herein in relation to FIG. 16.

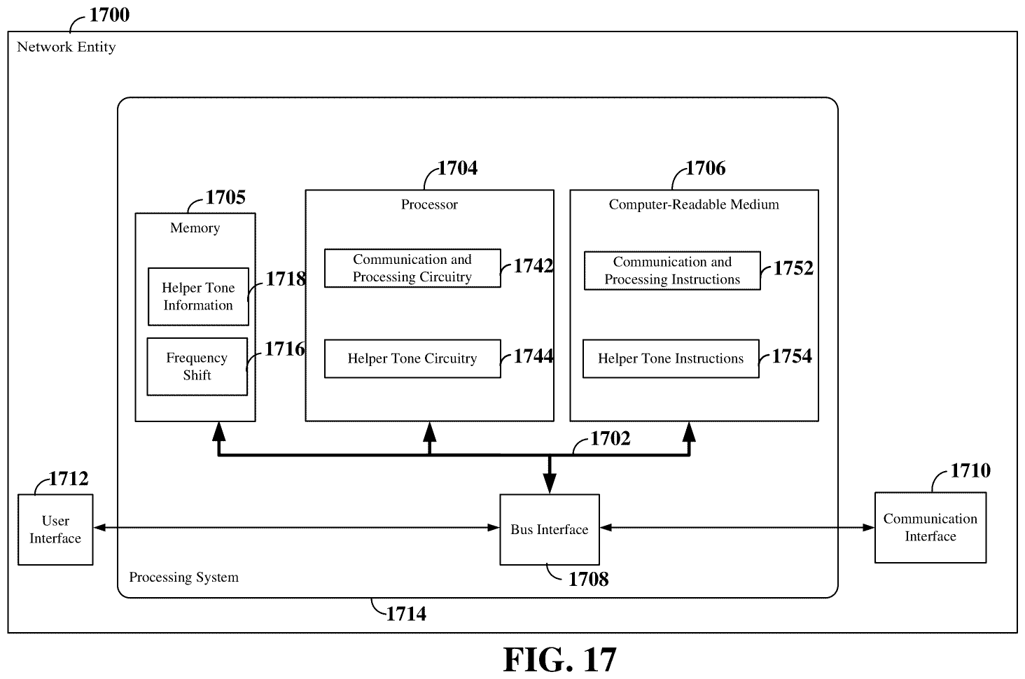

FIG. 17 is a conceptual diagram illustrating an example of a hardware implementation for an exemplary network entity 1700 employing a processing system 1714. For example, the network entity 1700 may correspond to any of the network entities (e.g., aggregated or disaggregated base stations) shown in any one or more of FIGS. 1, 3, 4-6, 8, and/or 9.

In accordance with various aspects of the disclosure, an element, or any portion of an element, or any combination of elements may be implemented with a processing system 1714 that includes one or more processors 1704. The processing system 1714 may be substantially the same as the processing system 1314 illustrated in FIG. 13, including a bus interface 1708, a bus 1702, memory 1705, a processor 1704, and a computer-readable medium 1706. Furthermore, the network entity 1700 may include an optional user interface 1712 and a communication interface (e.g., a transceiver and one or more antenna arrays). The processor 1704, as utilized in a network entity 1700, may be used to implement any one or more of the processes described herein. In some examples, the memory 1705 may store one or more of a frequency shift 1716 and/or helper tone information 1718 that may be utilized by the processor 1704 when executing software.

The processor 1704 may include communication and processing circuitry 1742 configured to communicate with one or more ambient IoT devices and/or one or more wireless energy transmitter (WET) devices. In some examples, the communication and processing circuitry 1742 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1742 may include one or more transmit/receive chains.

In some implementations where the communication involves receiving information, the communication and processing circuitry 1742 may obtain information from a component of the network entity 1700 (e.g., from the communication interface 1710 that receives the information via radio frequency signaling or some other type of signaling suitable for the applicable communication medium), process (e.g., decode) the information, and output the processed information. For example, the communication and processing circuitry 1742 may output the information to another component of the processor 1704, to the memory 1705, or to the bus interface 1708. In some examples, the communication and processing circuitry 1742 may receive one or more of signals, messages, other information, or any combination thereof. In some examples, the communication and processing circuitry 1742 may receive information via one or more channels. In some examples, the communication and processing circuitry 1742 may include functionality for a means for receiving. In some examples, the communication and processing circuitry 1742 may include functionality for a means for processing, including a means for demodulating, a means for decoding, etc.

In some implementations where the communication involves sending (e.g., transmitting) information, the communication and processing circuitry 1742 may obtain information (e.g., from another component of the processor 1704, the memory 1705, or the bus interface 1708), process (e.g., modulate, encode, etc.) the information, and output the processed information. For example, the communication and processing circuitry 1742 may output the information to the communication interface 1710 (e.g., that transmits the information via radio frequency signaling or some other type of signaling suitable for the applicable communication medium). In some examples, the communication and processing circuitry 1742 may send one or more of signals, messages, other information, or any combination thereof. In some examples, the communication and processing circuitry 1742 may send information via one or more channels. In some examples, the communication and processing circuitry 1742 may include functionality for a means for sending (e.g., a means for transmitting). In some examples, the communication and processing circuitry 1742 may include functionality for a means for generating, including a means for modulating, a means for encoding, etc.

The communication and processing circuitry 1742 may be configured to provide a downlink transmission to an ambient Internet of Things (IoT) device. In addition, the communication and processing circuitry 1742 may be configured to receive a modulated continuous wave (CW) signal backscattered from the IoT device based on a CW signal originated at a wireless energy transmitter (WET) device separate from the network entity. In some examples, the downlink transmission includes a frequency shift indication indicating a frequency shift (e.g., the frequency shift 1716) of the modulated CW signal with respect to the CW signal. In some examples, the downlink transmission is provided within a first frequency band and the modulated CW signal is received within a second frequency band. In this example, the first frequency band may be lower than the second frequency band. In some examples, the downlink transmission is provided on a data tone separated in frequency from a helper tone of the CW signal.

In some examples, the communication and processing circuitry 1742 may further be configured to provide helper tone information 1718 to the WET device. For example, the communication and processing circuitry 1742 may be configured to provide a primary synchronization signal including one or more bits containing the helper tone information. The communication and processing circuitry 1742 may further be configured to execute communication and processing instructions (software) 1752 stored in the computer-readable medium 1706 to implement one or more of the functions described herein.

The processor 1704 may further include helper tone circuitry 1744, configured to determine the helper tone information 1718. For example, the helper tone information 1718 may include at least one of an indication of the helper tone, an indication of the data tone, or power information associated with the CW signal on the helper tone. In some examples, the power information includes a schedule for transmission of the CW signal. The helper tone circuitry 1744 may further be configured to execute helper tone instructions (software) 1754 stored in the computer-readable medium 1706 to implement one or more of the functions described herein.

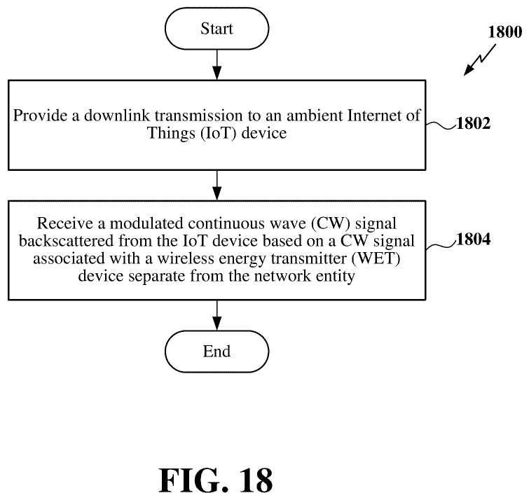

FIG. 18 is a flow chart of an exemplary process 1800 for enhancing communication between network entities and ambient IoT devices using wireless energy transmitter (WET) devices according to some aspects. As described below, some or all illustrated features may be omitted in a particular implementation within the scope of the present disclosure, and some illustrated features may not be required for implementation of all examples. In some examples, the method may be performed by the network entity 1700, as described above and illustrated in FIG. 17, by a processor or processing system, or by any suitable means for carrying out the described functions.

At block 1802, the network entity may provide a downlink transmission to an ambient Internet of Things (IoT) device. For example, the communication and processing circuitry 1742 together with the communication interface 1710, shown and described above in connection with FIG. 17, may provide a means to provide the downlink transmission.

At block 1804, the network entity may receive a modulated continuous wave (CW) signal backscattered from the IoT device based on a CW signal originated at a wireless energy transmitter (WET) device separate from the network entity. For example, the communication and processing circuitry 1742 together with the communication interface 1710, shown and described above in connection with FIG. 17, may provide a means to receive the modulated CW signal.

In some examples, the downlink transmission includes a frequency shift indication indicating a frequency shift of the modulated CW signal with respect to the CW signal. In some examples, the downlink transmission is provided within a first frequency band and the modulated CW signal is received within a second frequency band, in which the first frequency band is lower than the second frequency band.

In some examples, the downlink transmission is provided on a data tone separated in frequency from a helper tone of which the CW signal. In some examples, the network entity may provide helper tone information to the WET device. For example, the helper tone information may include at least one of an indication of the helper tone, an indication of the data tone, or power information associated with the CW signal on the helper tone. In some examples, the power information includes a schedule for transmission of the CW signal. In some examples, the network entity may provide a primary synchronization signal including one or more bits containing the helper tone information.

In one configuration, the network entity 1700 includes means for providing a downlink transmission to an ambient Internet of Things (IoT) device, and means for receiving a modulated continuous wave (CW) signal backscattered from the IoT device based on a CW signal originated at a wireless energy transmitter (WET) device separate from the network entity, as described in the present disclosure. In one aspect, the aforementioned means may be the processor 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1, 3, 4-6, 8, 9, and/or 17 utilizing, for example, the processes and/or algorithms described herein in relation to FIG. 18.

The processes shown in FIGS. 14, 16, and 18 may include additional aspects, such as any single aspect or any combination of aspects described below and/or in connection with one or more other processes described elsewhere herein.

Aspect 1: A method operable at a wireless energy transmitter (WET) device, the method comprising: configuring a continuous wave (CW) signal to avoid interference with a downlink transmission from a network entity; and transmitting the CW signal for wireless power transfer to at least one ambient Internet of Things (IoT) device.

Aspect 2: The method of aspect 1, further comprising: receiving a slot format indicator (SFI) from the network entity, the SFI identifying one or more downlink slots for communication from the network entity to the at least one ambient IoT device; and avoiding transmission of the CW signal within the one or more downlink slots.

Aspect 3: The method of aspect 1, wherein the transmitting the CW signal further comprises: transmitting the CW signal within a different frequency band than the downlink transmission.

Aspect 4: The method of aspect 3, wherein the CW signal is transmitted within a higher frequency band than the downlink transmission.

Aspect 5: The method of any of aspects 1 through 4, further comprising: acquiring frequency and time synchronization information from the network entity; and synchronizing transmission of the CW signal and other CW signals from other WETs using the frequency and time synchronization information.

Aspect 6: The method of aspect 1 or 5, wherein the transmitting the CW signal further comprises: transmitting the CW signal on a helper tone separated in frequency from a data tone of the downlink transmission.

Aspect 7: The method of aspect 6, further comprising: receiving helper tone information associated with the CW signal from the network entity.

Aspect 8: The method of aspect 7, wherein the helper tone information comprises at least one of an indication of the helper tone, an indication of the data tone, or power information associated with the CW signal sent on the helper tone.

Aspect 9: The method of aspect 8, wherein the power information comprises a schedule for transmission of the CW signal.

Aspect 10: The method of any of aspects 7 through 9, further comprising: receiving a primary synchronization signal comprising one or more bits containing the helper tone information.

Aspect 11: The method of any of aspects 6 through 10, further comprising: transmitting an additional CW signal within a higher frequency band than a frequency band on which the CW signal is transmitted.

Aspect 12: A wireless energy transmitter (WET) device comprising one or more memories and one or more processors coupled to the one or more memories, the one or more processors configured to perform a method of any of aspects 1 through 11.

Aspect 13: A wireless energy transmitter (WET) device comprising at least one means for performing a method of any one of aspects 1 through 11.

Aspect 14: A non-transitory computer-readable medium having stored therein instructions executable by one or more processors of a wireless energy transmitter (WET) device to perform a method of any one of aspects 1 through 11.

Aspect 15: A method operable at an ambient Internet of Things (IoT) device, comprising: receiving a continuous wave (CW) signal for wireless power transfer from a wireless energy transmitter (WET) device; backscattering and modulating at least the CW signal to produce a modulated CW signal; and transmitting the modulated CW signal to a network entity separate from the WET device.

Aspect 16: The method of aspect 15, further comprising: receiving a frequency shift indication from the network entity, the frequency shift indication indicating a frequency shift to be applied to the CW signal; and applying the frequency shift to the CW signal to produce the modulated CW signal at a shifted frequency.

Aspect 17: The method of aspect 16, wherein the frequency shift is less than a mono-static frequency shift applied to other signals from the network entity backscattered by the ambient IoT device.

Aspect 18: The method of any of aspects 15 through 17, further comprising: receiving a downlink transmission from the network entity, wherein the CW signal is received in a different frequency band than the downlink transmission.

Aspect 19: The method of aspect 18, wherein the CW signal is received in a higher frequency band than the downlink transmission.

Aspect 20: The method of any of aspects 15 through 17, further comprising: receiving a downlink transmission from the network entity on a data tone separated in frequency from a helper tone carrying the CW signal; and applying envelope detection to the downlink transmission using the data tone and the helper tone.

Aspect 21: An ambient Internet of Things (IoT) device comprising one or more memories and one or more processors coupled to the one or more memories, the one or more processors configured to perform a method of any of aspects 15 through 20.

Aspect 22: An ambient Internet of Things (IoT) device comprising at least one means for performing a method of any one of aspects 15 through 20.

Aspect 23: A non-transitory computer-readable medium having stored therein instructions executable by one or more processors of an ambient Internet of Things (IoT) device to perform a method of any one of aspects 15 through 20.

Aspect 24: A method operable at a network entity, comprising: providing a downlink transmission to an ambient Internet of Things (IoT) device; and receiving a modulated continuous wave (CW) signal backscattered from the IoT device based on a CW signal originated at a wireless energy transmitter (WET) device separate from the network entity.

Aspect 25: The method of aspect 24, wherein the downlink transmission comprises a frequency shift indication indicating a frequency shift of the modulated CW signal with respect to the CW signal.

Aspect 26: The method of aspect 24 or 25, wherein the downlink transmission is provided within a first frequency band and the modulated CW signal is received within a second frequency band, the first frequency band being lower than the second frequency band.

Aspect 27: The method of aspect 24 or 25, wherein the downlink transmission is provided on a data tone separated in frequency from a helper tone associated with the WET device.

Aspect 28: The method of aspect 27, further comprising: providing helper tone information to the WET device.

Aspect 29: The method of aspect 28, wherein the helper tone information comprises at least one of an indication of the helper tone, an indication of the data tone, or power information associated with the CW signal on the helper tone.

Aspect 30: The method of aspect 29, wherein the power information comprises a schedule for transmission of the CW signal.

Aspect 31: The method of any of aspects 28 through 30, wherein the providing the helper tone information further comprises: providing a primary synchronization signal comprising one or more bits containing the helper tone information.

Aspect 32: A network entity comprising one or more memories and one or more processors coupled to the one or more memories, the one or more processors configured to perform a method of any of aspects 24 through 31.

Aspect 33: A network entity comprising at least one means for performing a method of any one of aspects 24 through 31.

Aspect 34: A non-transitory computer-readable medium having stored therein instructions executable by one or more processors of a network entity to perform a method of any one of aspects 24 through 31.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 3, 4-6, 8, 9, 13, 15, and/or 17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A wireless energy transmitter (WET) device, comprising:
one or more memories; and
one or more processors coupled to the one or more memories, wherein the one or more processors are configured to:
configure a continuous wave (CW) signal to avoid interference with a downlink transmission from a network entity; and
transmit the CW signal for wireless power transfer to at least one ambient Internet of Things (IoT) device.

2. The WET device of claim 1, wherein the one or more processors are further configured to:
receive a slot format indicator (SFI) from the network entity, the SFI identifying one or more downlink slots for communication from the network entity to the at least one ambient IoT device; and
avoid transmission of the CW signal within the one or more downlink slots.

3. The WET device of claim 1, wherein the one or more processors is further configured to:
transmit the CW signal within a different frequency band than the downlink transmission.

4. The WET device of claim 3, wherein the CW signal is transmitted within a higher frequency band than the downlink transmission.

5. The WET device of claim 1, wherein the one or more processors are further configured to:
acquire frequency and time synchronization information from the network entity; and
synchronize transmission of the CW signal and other CW signals from other WETs using the frequency and time synchronization information.

6. The WET device of claim 1, wherein the one or more processors are further configured to:
transmit the CW signal on a helper tone separated in frequency from a data tone of the downlink transmission.

7. The WET device of claim 6, wherein the one or more processors are further configured to:
receive helper tone information associated with the CW signal from the network entity.

8. The WET device of claim 7, wherein the helper tone information comprises at least one of an indication of the helper tone, an indication of the data tone, or power information associated with the CW signal sent on the helper tone.

9. The WET device of claim 8, wherein the power information comprises a schedule for transmission of the CW signal.

10. The WET device of claim 7, wherein the one or more processors are further configured to:
receive a primary synchronization signal comprising one or more bits containing the helper tone information.

11. The WET device of claim 6, wherein the one or more processors are further configured to:
transmit an additional CW signal within a higher frequency band than a frequency band on which the CW signal is transmitted.

12. An ambient Internet of Things (IoT) device, comprising:
one or more memories; and
one or more processors coupled to the one or more memories, wherein the one or more processors are configured to:
receive a continuous wave (CW) signal for wireless power transfer from a wireless energy transmitter (WET) device;
backscatter and modulate at least the CW signal to produce a modulated CW signal; and
transmit the modulated CW signal to a network entity separate from the WET device.

13. The ambient IoT device of claim 12, wherein the one or more processors are further configured to:
receive a frequency shift indication from the network entity, the frequency shift indication indicating a frequency shift to be applied to the CW signal; and
apply the frequency shift to the CW signal to produce the modulated CW signal at a shifted frequency.

14. The ambient IoT device of claim 13, wherein the frequency shift is less than a mono-static frequency shift applied to other signals from the network entity backscattered by the ambient IoT device.

15. The ambient IoT device of claim 12, wherein the one or more processors are further configured to:
receive a downlink transmission from the network entity, wherein the CW signal is received in a different frequency band than the downlink transmission.

16. The ambient IoT device of claim 15, wherein the CW signal is received in a higher frequency band than the downlink transmission.

17. The ambient IoT device of claim 12, wherein the one or more processors are further configured to:
receive a downlink transmission from the network entity on a data tone separated in frequency from a helper tone carrying the CW signal; and
apply envelope detection to the downlink transmission using the data tone and the helper tone.

18. A network entity, comprising:
one or more memories; and
one or more processors coupled to the one or more memories, wherein the one or more processors are configured to:
provide a downlink transmission to an ambient Internet of Things (IoT) device; and
receive a modulated continuous wave (CW) signal backscattered from the ambient IoT device based on a CW signal originated at a wireless energy transmitter (WET) device separate from the network entity.

19. The network entity of claim 18, wherein the downlink transmission comprises a frequency shift indication indicating a frequency shift of the modulated CW signal with respect to the CW signal.

20. The network entity of claim 18, wherein the downlink transmission is provided within a first frequency band and the modulated CW signal is received within a second frequency band, the first frequency band being lower than the second frequency band.

21. The network entity of claim 18, wherein the downlink transmission is provided on a data tone separated in frequency from a helper tone associated with the WET device.

22. The network entity of claim 21, wherein the one or more processors are further configured to:
provide helper tone information to the WET device.

23. The network entity of claim 22, wherein the helper tone information comprises at least one of an indication of the helper tone, an indication of the data tone, or power information associated with the CW signal sent by the WET device on the helper tone.

24. The network entity of claim 23, wherein the power information comprises a schedule for transmission of the CW signal.

25. The network entity of claim 22, wherein the one or more processors are further configured to:
provide a primary synchronization signal comprising one or more bits containing the helper tone information.

26. A method operable at a wireless energy transmitter (WET) device, the method comprising:
configuring a continuous wave (CW) signal to avoid interference with a downlink transmission from a network entity; and
transmitting the CW signal for wireless power transfer to at least one ambient Internet of Things (IoT) device.

27. The method of claim 26, further comprising:
receiving a slot format indicator (SFI) from the network entity, the SFI identifying one or more downlink slots for communication from the network entity to the at least one ambient IoT device; and
avoiding transmission of the CW signal within the one or more downlink slots.

28. The method of claim 26, wherein the transmitting the CW signal further comprises:
transmitting the CW signal within a different frequency band than the downlink transmission.

29. The method of claim 26, further comprising:
acquiring frequency and time synchronization information from the network entity; and
synchronizing transmission of the CW signal and other CW signals from other WETs using the frequency and time synchronization information.

30. The method of claim 26, wherein the transmitting the CW signal further comprises:
transmitting the CW signal on a helper tone separated in frequency from a data tone of the downlink transmission.
